(19) United States
(12) Patent Application Publication
(10) Pub. No.: US 2007/0051029 A1
(43) Pub. Date: Mar. 8, 2007

(54) WATERFOWL DECOY

(76) Inventor: John Steven Ring, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/468,045

(22) Filed: Aug. 29, 2006

Related U.S. Application Data
(60) Provisional application No. 60/713,779, filed on Sep. 2, 2005.

(51) Int. Cl. A01M 31/06

(52) U.S. Cl. 43/2

(57) ABSTRACT

Novel decoys are provided that attract waterfowl to a particular location lacking a body of water by creating the illusion of water. The decoys are particularly effective for use in farm fields or similar locations where a dispersed food source exists. The illusion of a body of water created by the decoys can focus the waterfowl's movement to that focal point where one or more hunters can wait for their approach. Additionally, methods are provided for utilizing the novel waterfowl decoys.

This application claims the benefit of U.S. Provisional Patent Application Ser. No. 60/713,779 filed on Sep. 2, 2005, which is incorporated herein by reference in its entirety.

### BACKGROUND

This disclosure relates generally to a waterfowl decoy used to attract waterfowl and the like to regions lacking a body of water by creating an illusion of water viewed from an aerial perspective.

Over the years hunters have employed a variety of means to lure waterfowl within the range of their weapons. The more common approaches have utilized a form of decoy represented by other waterfowl or bait represented by an appropriate food item. Decoys have generally represented the presence of waterfowl by employing caged or tethered live waterfowl, three dimensional replicas of waterfowl, and pictorial representations of waterfowl. Similarly, baits employed have included actual food sources, such as whole or partial ears of corn, replicas of the food materials and pictorial representations of corn and other grains. Because waterfowl are generally drawn to bodies of water the various decoys and baits have generally been placed in the vicinity of existing ponds, lakes and other bodies of water.

Farming areas, such as found in the Midwest, frequently have vast flat or generally rolling areas that can, in the case of farm fields, contain a source of grain. However, the lack of a body of water as a focal point can fail to attract a significant number of waterfowl to a particular spot where a hunter can wait for their approach. What is needed is a decoy for attracting waterfowl which can be positioned by a hunter at a site lacking a body of water. The decoy should provide the illusion of water, as a focal point, from an aerial perspective and cause the waterfowl to approach and/or land near the illusory water, thus bringing them within the hunter's range.

### SUMMARY

One aspect of the current disclosure is a waterfowl decoy that comprises a mat or a number of mats, each mat having a surface region that contains a colored portion such that when the mats are arranged individually or collectively in a planar or substantially planar configuration, the colored portion or portions depict or provide an illusion of water when viewed from an aerial perspective. Preferred mats are constructed from a non-woven material. The surface region responsible for the illusion can be provided by a single mat or a collection of mats and can include a mat's entire surface or only a portion of a mat's surface. The surface region responsible for the illusion of water should be sufficiently large to be visible from an aerial perspective. However, individual decoy mats should not be so large as to make handling, positioning and maintaining the mat in a desired position on the ground difficult. Surface regions capable of providing the illusion of water (the “illusory regions”) can have a variety of sizes, shapes and colors as discussed herein. Preferred mats are held in place with a plurality of anchors. Similarly, preferred mats lack any pictorial representation of either waterfowl or food typically consumed by waterfowl.

A further aspect of the current disclosure provides for a method of attracting waterfowl that includes selecting at least one of the novel waterfowl decoys described herein, selecting a site that provides waterfowl aerial access and an aerial view of the site, positioning the decoy mats in a generally planar position to expose the decoy's illusory surface to an aerial view from that site and anchoring the mats with a plurality of anchors. Preferred sites are generally open regions providing an aerial view from several directions and where the immediate terrain beneath the mat is generally flat. Particularly preferred sites are locations where grain or other food sources are in the immediate area. Such a preferred site is a farm field where a grain has been grown and harvested. Such farm sites typically have varying amounts of grain remaining on the ground.

### DESCRIPTION OF THE DRAWINGS

FIG. 1 is an overhead perspective view of a waterfowl decoy derived from a single mat having an illusory region that coincides with the mat's surface, wherein the mat is anchored with stakes either directly or in combination with one or more cords.

FIG. 2 is an overhead perspective view of a waterfowl decoy derived from a single mat having an illusory region that coincides with only a portion of the mat's surface, wherein the mat is anchored with weights contained in pockets about the mat's circumference.

FIG. 3 is an overhead perspective view of a waterfowl decoy derived from a plurality of mats having an illusory region that coincides with only a portion of the mat's collective surface.

FIG. 4 is an overhead perspective view of a waterfowl decoy derived from a plurality of mats having an illusory region that coincides with only a portion of the mat's collective surfaces wherein the plurality of mats have been positioned between adjacent rows in a field having a crop that has been harvested.

FIG. 5 is a close-up view of an overhead perspective of a portion of a waterfowl decoy of the type illustrated in FIG. 4.

### DESCRIPTION

For purposes of promoting an understanding of the principles of this disclosure, reference will now be made to specific embodiments and specific language will be used to describe the same. It will nevertheless be understood that no limitation of the scope of the disclosure is thereby intended. Any alterations and modifications in the described disclosure, and any further applications of the principles of the disclosure as illustrated therein are contemplated as would normally occur to one skilled in the art to which the disclosure relates.

It is one aspect of the present disclosure to provide a decoy for attracting waterfowl that can depict an aerial view or an illusion of a body of water from a waterfowl's aerial perspective and cause one or more birds to approach the illusion. To create the illusion of a body of water one or more decoy mats are positioned that individually or collectively provide a surface that individually or collectively displays a surface region having a size, shape and color consistent with typical aerial views of water.

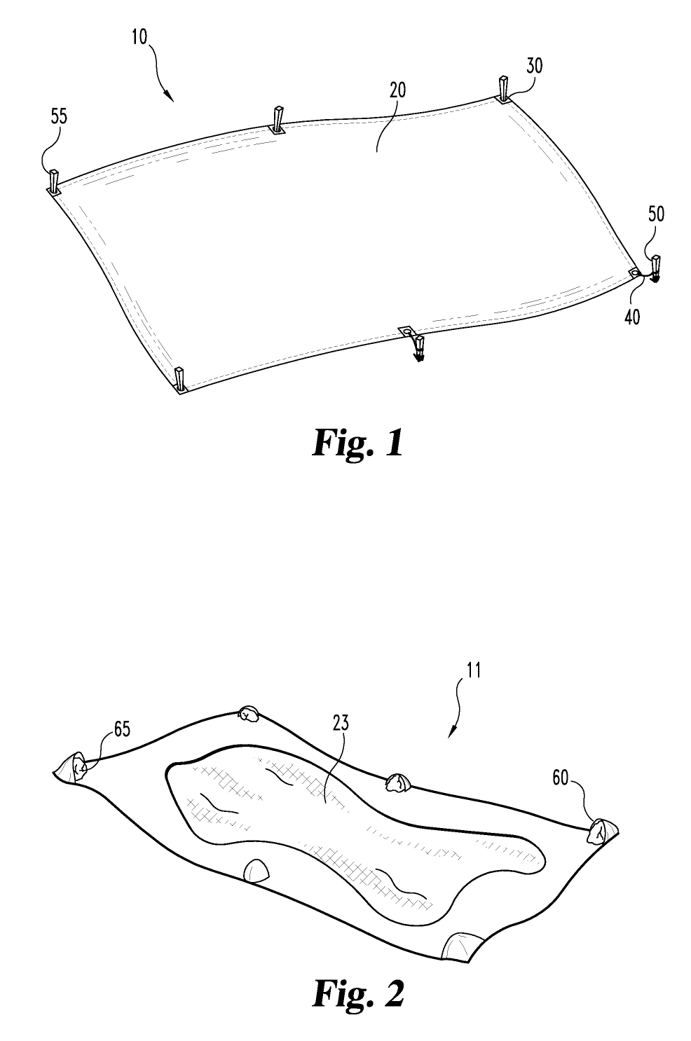

One preferred aspect of the present disclosure involves a waterfowl decoy comprising a single decoy mat with a surface region having a colored portion capable of providing the illusion of water from an aerial view. Although such mats can have shapes that include square, rectangular, circular, oval, or other irregular shape, rectangular mats have generally been preferred. Generally rectangular decoy mats are generally easier to maneuver, can provide a substantial surface area, and can be positioned to fit into a wider variety of terrains. The surface region responsible for the illusion can coincide with the shape of the decoy mat or have a different shape covering only a portion of the mat's surface. FIG. 1 illustrates such a rectangular mat 10 having an illusory region 20 that coincides with the mat's entire surface. Preferred illusory regions have shapes that include generally oval, generally circular or another regular or irregular shape typical of bodies of water. FIG. 2 illustrates such a mat 11 having an illusory region 21 that doesn't coincide with the mat's entire surface. A single mat's size is generally a compromise between being larger to improve visibility and smaller to make handling easier. Single mats having a surface area of as much as 100 ft² can generally be placed and otherwise handled by two or more individuals.

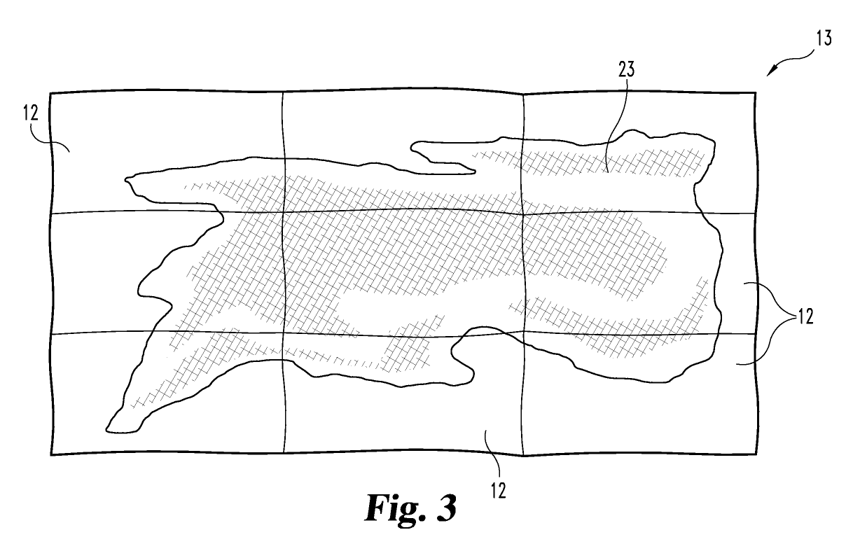

A further preferred aspect of the present disclosure involves a waterfowl decoy comprising a plurality of decoy mats assembled to provide a combined illusory surface region derived from a combined colored portion visible from an aerial view. The combined illusory surface region can coincide with the entire surface of the plurality of mats or a portion of the combined surface. Although the decoy mats making up the plurality of mats can have a variety of shapes, substantially rectangular or substantially square mats are generally preferred. Rectangular mats ranging in width from about 15 inches to about 30 inches and ranging in length from about 8 feet to about 15 feet can be easily assembled by one or two individuals to provide combined surface regions representing much larger illusory bodies of water. Like the illusory surface region on a single mat, the illusory surface region provided on the surface of a plurality of mats should have a shape typical of bodies of water. FIG. 3 illustrates a plurality of mats 13 assembled from individual mats 12 in a manner to provide a combined illusory region 23.

The decoy mats, whether assembled individually or collectively, can be constructed from a variety of flexible materials. Preferred materials of construction are non-woven sheets having a thickness ranging from about 1 to about 5 mils. Extruded plastic materials; such as for example, polyvinylchloride, polyethylene or polypropylene; are particularly suitable non-woven materials and provide a suitable level of reflection to simulate water from an aerial perspective. For mats having an illusory region corresponding to the mat's entire surface, the mat can be constructed from a non-woven material having the color incorporated within the material. For mats having illusory regions that differ from the mat's surface, the illusory region can be printed or otherwise applied to a portion of the mat's surface. The non-woven material used to prepare decoy mats having an illusory region printed or otherwise applied to the mat's surface is preferably either clear or a color that corresponds to the color of the soil, vegetative surroundings, or other background in the region where the decoy will be used.

The illusory region of the mat's surface can be any color that corresponds to bodies of water in the location where the decoy mat will be utilized. Generally, because of water's reduced reflectivity, a body of water viewed from an aerial perspective will appear darker than other solid surroundings. Some typical colors include, but are not limited to the darker shades of green, brown, blue, charcoal gray and black. Mats having surfaces that are dark green and brown are generally preferred for use in areas having large regions of exposed topsoil, such as farming areas, where bodies of water typically contain suspended soil particles. Illusory regions that are shades of dark blue to dark blue-green are generally more suitable for regions more fully covered with vegetation or outcroppings of rock. In these regions, lakes, ponds and the like generally contain a lesser amount of suspended soil particles. Illusory regions that are charcoal gray or black are also suitable and generally suggest a deeper body of water. In areas having reddish colored soil, such as Georgia, an illusory region having a dark reddish-brown color would be suitable. Colored photographs of aerial views of water in various geographical locations can be viewed over the internet or from other sources to better understand the preferred colorings for the illusory regions for different locations.

Because the waterfowl decoys described herein are constructed from generally lightweight materials that can easily be moved by even a mild breeze, applicant's preferred waterfowl decoys have a plurality of anchors about the circumference each mat. Anchors can comprise simple weights that rest on a portion of the surface or that are in pockets of the mat. FIG. 2 illustrates anchors 65 such as for example rocks or metallic bodies encased in pockets 60 about the circumference of mat 11. Other anchors can comprise a series of stakes that are either directly attached to the mat or are attached through a cord or the like. FIG. 1 illustrates the use of stakes 55 used through opening 30 to directly maintain the mat 10 on the ground and stakes 50 attached through a cord 40 to maintain the mat 10 on the ground. Mats having anchors that allow the wind to cause the mat to undulate slightly above the ground's surface can provide the illusion of ripples or waves moving across a water's surface and can enhance the decoy's perception as a body of water.

It is a further aspect of the present disclosure to provide a method for attracting waterfowl to the decoy's proximity where a hunter can lie in wait. Applicant's method involves, selecting at least one flexible mat having a colored portion to provide an illusory region on one surface, the illusory surface having a size, shape, color and reflectivity capable of providing the illusion of water from an aerial perspective; selecting a site providing waterfowl aerial access; positioning the any mats selected to expose the mat's illusory surface region to an aerial view at the site; and anchoring any mats selected to maintain their position. One or a plurality of the mats described herein are suitable for being selected according to applicant's method.

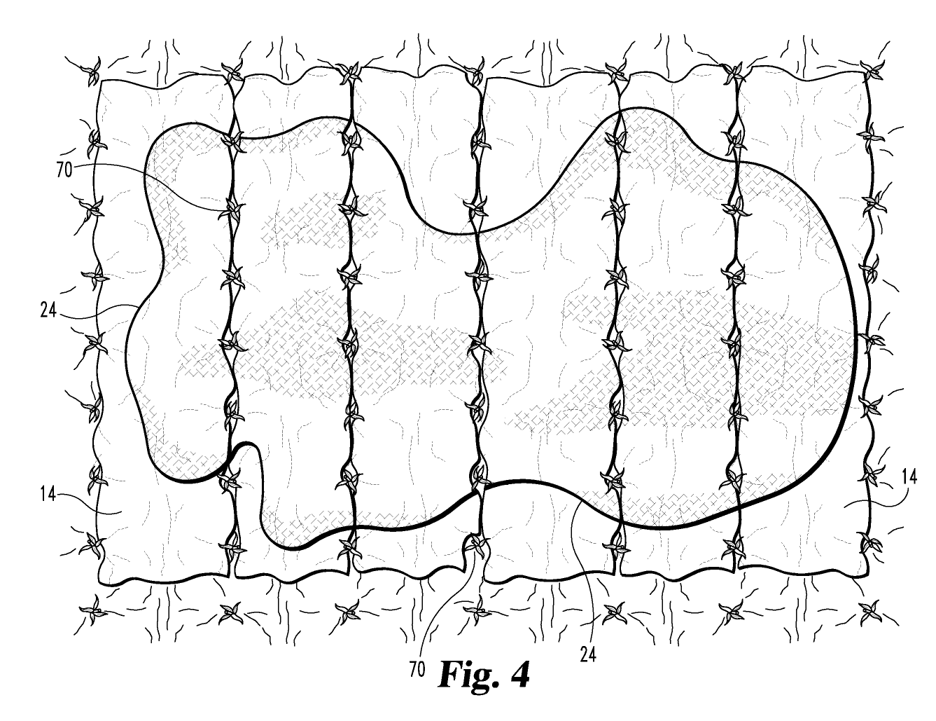

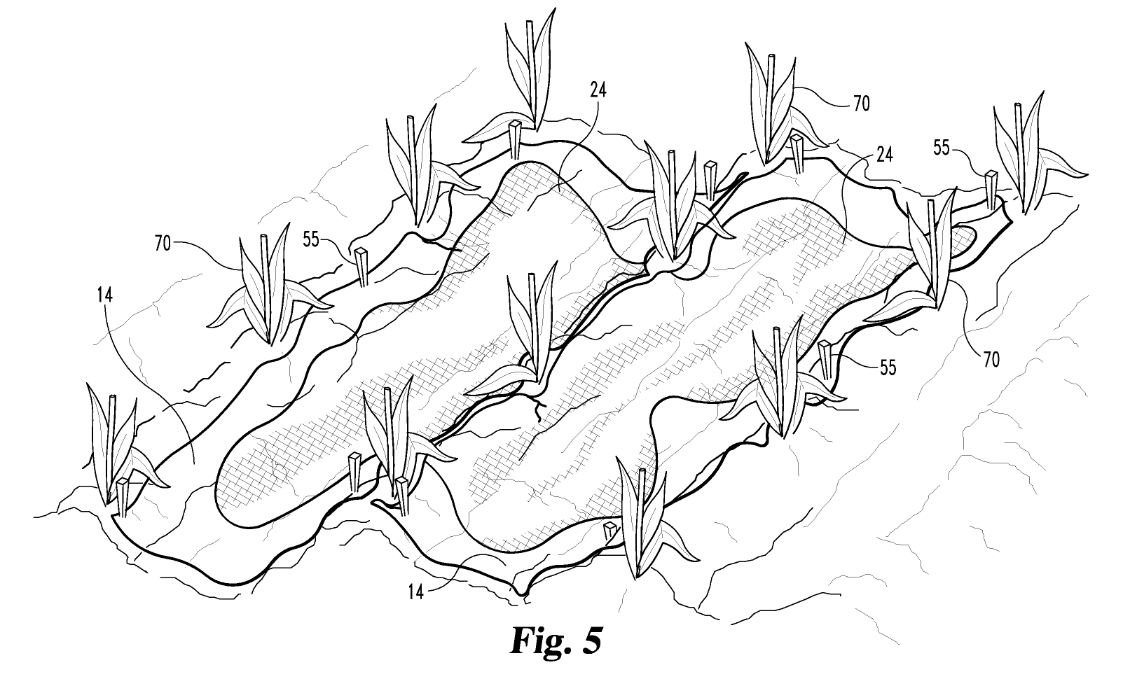

Although any site providing an aerial view of the decoy can be selected, some sites are preferred. First, sites that are beneath regions where waterfowl are regularly sited are preferred. Similarly, sites that have a food source for waterfowl nearby are similarly preferred. For example, farm-fields in the Midwest where a grain crop was recently harvested typically have some grain remaining that can attract waterfowl. A plurality of mats having a narrow rectangular shape that will fit between the harvested corn rows can provide a collective illusory region that has proven particularly effective. FIG. 4 illustrates the use of a plurality of narrow rectangular decoy mats 14 placed between adjacent rows of remnant corn stalks 70. The plurality of decoy mats provides a collective illusory region 24 about the several remnant corn stalks 70. From an aerial view the remaining remnant corn-stalks 70 resemble water-plants growing just above the illusory surface 24. Sites providing the hunter some nearby natural cover are also preferred. Such sites are often at or near the edge of a farm-field or meadow. Artificial cover, taught in the art, can also be provided at other sites lacking any natural cover.

While applicant's disclosure has provided the details of specific embodiments, it will be understood that modifications and alterations in the embodiments disclosed may be made by those practiced in the art without departing from the spirit and scope of the present disclosure. All such modifications and alterations are intended to be covered.

What is claimed is:

1. A decoy for attracting waterfowl comprising at least one flexible mat constructed from a non-woven polymeric material, said mat having a surface region, wherein said surface region has a colored portion adapted to depict an aerial view of a body of water; and wherein said mat is adapted to: (i) be positioned in a substantially planar configuration and (ii) be held in place by a plurality of anchors.

2. The decoy of claim 1, wherein said surface region lacks any pictorial representation of a waterfowl or a food typically consumed by waterfowl.

3. The decoy of claim 1, wherein said mat has a surface area of less than about 100 ft².

4. The decoy of claim 1, wherein said colored portion comprises a color selected from the group consisting of brown, blue, green, charcoal gray, reddish brown, and black.

5. The decoy of claim 1, wherein said mat has a thickness of from about 1 to about 5 mils.

6. The decoy of claim 1, wherein said mat is constructed of a material selected from the group consisting of polyvinylchloride, polyethylene and polypropylene.

7. The decoy of claim 4, wherein said color is applied to said surface region of said mat.

8. The decoy of claim 4, wherein said color is contained throughout said non-woven polymeric material.

9. The decoy of claim 1, wherein said anchors are selected from the group consisting of stakes, a combination of stakes and cords, and weights.

10. A decoy for attracting waterfowl comprising a plurality of flexible mats constructed from a non-woven polymeric material, said mats having a collective surface region; wherein said collective surface region has a collective colored portion adapted to depict an aerial view of a body of water; and wherein said mats are adapted to: (i) be positioned in a substantially planar configuration and (ii) held in place by a plurality of anchors.

11. The decoy of claim 10, wherein said collective surface region lacks any pictorial representation of a waterfowl or a food typically consumed by waterfowl.

12. The decoy of claim 10, wherein said collective surface region has a surface area of less than about 100 ft².

13. The decoy of claim 10, wherein said collective colored portion comprises a color selected from the group consisting of brown, blue, green, charcoal gray, reddish brown, and black.

14. The decoy of claim 10, wherein said plurality of mats have a thickness of from about 1 to about 5 mils.

15. The decoy of claim 10, wherein said plurality of mats are constructed of a material selected from the group consisting of polyvinylchloride, polyethylene and polypropylene.

16. The decoy of claim 13, wherein said color is applied to said collective surface region of said mats.

17. The decoy of claim 13, wherein said color is contained throughout said non-woven polymeric material.

18. The decoy of claim 10, wherein said plurality of anchors are selected from the group consisting of stakes, a combination of stakes and cords, and weights.

19. A method for attracting waterfowl comprising:
(a) selecting (i) at least one flexible mat constructed from a non-woven polymeric material, said mat having a surface region wherein said surface region has a colored portion adapted to depict an aerial view of a body of water and (ii) a plurality of anchors;
(b) selecting a site providing waterfowl aerial access; and
(c) positioning said mat in a substantially planar position at said site to expose said surface region to an aerial view;
(d) anchoring said mat with said plurality of anchors.

20. The method of claim 19, wherein selecting involves selecting a plurality of mats and said surface region is a collective surface region having a collective colored portion.

21. The method of claim 20, wherein said positioning involves positioning said mats in a farm field along and between crop rows.
